(19) United States
(12) Patent Application Publication
(10) Pub. No.: US 2024/0321494 A1
(43) Pub. Date: Sep. 26, 2024

(54) MAGNETIC ELEMENT AND MANUFACTURING METHOD

(71) Applicant: SHANGHAI PANGOOD POWER TECHNOLOGY CO., LTD, Shanghai (CN)

(72) Inventors: Lei TANG, Shanghai (CN); Li XIA, Shanghai (CN); Xiutao JI, Shanghai (CN); Guangquan ZHANG, Shanghai (CN); Jinhua CHEN, Shanghai (CN)

(73) Assignee: SHANGHAI PANGOOD POWER TECHNOLOGY CO., LTD, Shanghai (CN)

(21) Appl. No.: 18/577,236

(22) PCT Filed: May 19, 2022
(86) PCT No.: PCT/CN2022/093787

§ 371 Date: Jan. 5, 2024

(30) Foreign Application Priority Data
Jan. 26, 2022 (CN) 202210094585.2

(51) Int. Cl. H01F 7/02; H01F 27/34; H01F 41/02

(52) U.S. Cl. CPC H01F 7/021; H01F 27/34; H01F 41/0253; H01F 2027/348

(57) ABSTRACT

A magnetic element includes a plurality of magnetic units, where the plurality of magnetic units are arranged in sequence; a groove and a connecting portion are provided between adjacent magnetic units; the grooves are used for blocking an eddy current path; the connecting portions connect adjacent magnetic units; and the connecting portions are connected to the grooves and prevent the grooves from completely penetrating through adjacent magnetic units. The connecting portions and the magnetic units are made of the same material and are integrally formed, such that the overlapping and bonding processes are omitted, the production efficiency of the magnetic element is effectively improved.

### CROSS-REFERENCE TO RELATED APPLICATION

The present application is a National Stage Application of PCT International Application No.: PCT/CN2022/093787 filed on May 19, 2022, which claims priority to Chinese Patent Application 202210094585.2, filed in the China National Intellectual Property Administration on Jan. 26, 2022, the disclosure of which is incorporated herein by reference in its entirety.

### TECHNICAL FIELD

The present application relates to a magnetic element and a manufacturing method, and in particular to a magnetic element used in an electromagnetic device and a manufacturing method therefor.

### BACKGROUND

Electromagnetic devices are used to generate electromagnetism for operation, and are divided into electric motors, electromagnets and so on. An electric motor, as an example, includes a rotating part called a rotor and a stationary part called a stator, and the rotor and the stator are combined to generate torque. Generally speaking, the stator of the electric motor includes a stator core and a winding that receives current and is used for operation. The rotor is provided with multiple magnets, and the stator and the rotor interact to allow the rotor to rotate relative to the stator.

When a magnetic element, such as a magnet, moves in a non-uniform magnetic field or is in a time-varying magnetic field, the current induced in the magnetic element leads to energy loss, which is called eddy current loss. The eddy current loss causes heating up of the magnetic element, thereby affecting the operating performance of the electric motor. The most common way to reduce eddy current loss is by segmentation, and the multiple magnetic segments “a” after segmentation (such as silicon steel sheets) are stacked to form the magnetic element. Referring to FIG. 1, a gap between two adjacent magnetic segments “a” can block an eddy current path, thereby reducing the eddy current loss of the magnetic element.

However, the above segmentation way has the following defects.

Firstly, two adjacent magnetic segments are required to be bonded by an adhesive, the manufacturing process is cumbersome, time-consuming and laborious, and the cost is increased significantly due to the use of additional adhesive.

Secondly, the magnetic element currently is segmented by cutting, there are a lot of scrap materials being produced during the cutting process, resulting in a low material utilization rate.

Thirdly, an insulation layer is required to be attached to a surface of the magnetic segment, and insulation coatings can only be sprayed on the surfaces of the magnetic segments one by one due to the segmentation, which not only decreases the efficiency, but also may easily lead to the failure of the insulation layer due to poor adhesion performance of spraying.

### SUMMARY

In order to solve the above problems, a magnetic element and a manufacturing method therefor are provided according to the present application, to effectively reduce costs and improve production efficiency.

According to an object of the present application, a magnetic element is provided according to the present application, which includes multiple magnetic units. The multiple magnetic units are arranged in sequence, a groove and a connecting portion are provided between each two adjacent magnetic units, the groove is configured to block an eddy current path, and the connecting portion is configured to connect the corresponding adjacent magnetic units, the connecting portion is connected to the groove to block the groove from completely penetrating between the adjacent magnetic units. The connecting portion and the multiple magnetic units are made of a same material and are integrally formed.

In a preferred solution, the connecting portion is located at a middle position of the corresponding two adjacent magnetic units to allow the groove to be formed on each of both sides of the connecting portion.

In a preferred solution, a line connecting centers of multiple connecting portions is perpendicular to a length direction of each of the multiple magnetic units.

In a preferred solution, one said connecting portion and one said groove are provided between each two adjacent magnetic units, and the grooves are arranged on both sides of the magnetic element in a staggered manner to form the magnetic element being of a structure having S-shapes.

In a preferred solution, the connecting portion is flush with both sides of the magnetic element in a thickness direction.

In a preferred solution, the groove penetrates through the magnetic element in the thickness direction of the magnetic element.

In a preferred solution, a width of the groove ranges from 0.05 mm to 0.2 mm.

In a preferred solution, the groove is filled with an insulating material.

According to another object of the present application, a method for manufacturing the magnetic element described above is also provided according to the present application, which includes the following steps:
preparing an integral magnetic element of a desired shape; and
   cutting the integral magnetic element to form the groove on each of both sides of the magnetic element, and reserving a margin during cutting to form the connecting portion.

In a preferred solution, overall electroplating or spraying is performed on the magnetic element after being cut, to form an insulation layer on a surface of the magnetic element.

Compared with the conventional technology, the technical solutions of the present application have the following advantages.

The grooves are provided on both sides of the magnetic element to block the eddy current path and reduce the eddy current loss. The magnetic unit is defined between two adjacent grooves, and the connecting portion is reserved to integrally connect the two adjacent magnetic units when the groove is cut. The connecting portion prevents the groove from completely penetrating between the two adjacent magnetic units, so that the magnetic element is continuous and of a one-piece structure. Compared with the manner in the conventional technology that the segments being stacked, the stacking and bonding processes are omitted, which effectively improves the production efficiency of the magnetic element. Moreover, compared with the manner that the segments being stacked, excessive scrap materials being produced in the cutting process is avoided, which effectively improves the utilization rate of materials, in addition, adhesives required for the bonding process are omitted, thereby further reducing the cost. In addition, the grooves located on both sides of the magnetic element may be arranged in one-to-one correspondence or in a staggered manner to adapt to the magnetic elements with different shapes, so as to ensure that the magnetic element has the grooves that block the eddy current path on the premise of having corresponding structural strength, thereby achieving implementability and improving applicability.

The present application is further described below in conjunction with the drawings and the embodiments.

### BRIEF DESCRIPTION OF THE DRAWINGS

FIG. 1 is a schematic view showing the structure of a magnetic element in the conventional technology;

FIG. 2 is a schematic view showing the structure of a magnetic element according to a first embodiment of the present application;

FIG. 3 is a schematic view showing the structure of a magnetic element according to a second embodiment of the present application;

FIG. 4 is a schematic view showing the structure of a magnetic element according to a third embodiment of the present application; and

FIG. 5 is a schematic view showing the structure of a magnetic element according to a fourth embodiment of the present application.

### DETAILED DESCRIPTION OF THE EMBODIMENTS

The following description is provided to disclose the present application to enable those skilled in the art to implement the present application. The preferred embodiments in the following description are only examples, and those skilled in the art can think of other obvious modifications. The basic principles of the present application defined in the following description may be applied to other embodiments, variations, improvements, equivalents, and other technical solutions without departing from the scope of the present application.

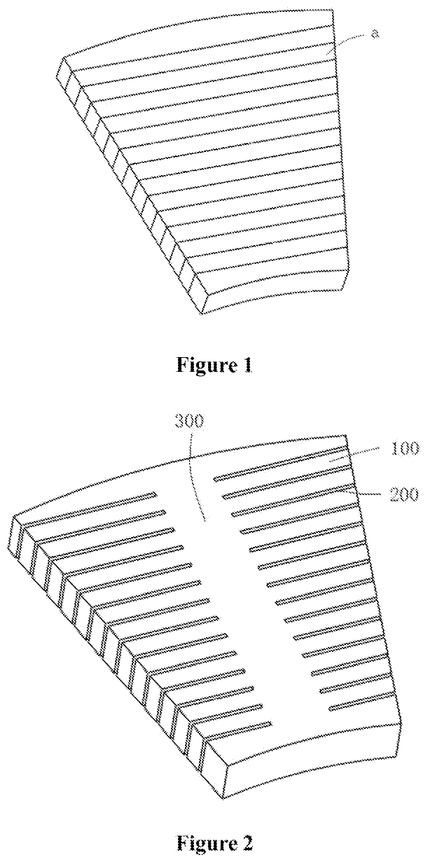

As shown in FIGS. 2 to 5, a magnetic element includes multiple magnetic units 100. The multiple magnetic units 100 are arranged in sequence, a groove 200 and a connecting portion 300 are provided between each two adjacent magnetic units 100. The groove 200 is configured to block an eddy current path, the connecting portion 300 connects the corresponding adjacent magnetic units 100. The connecting portion 300 is connected to the groove 200 to block the groove 200 from completely penetrating between the adjacent magnetic units 100. The connecting portion 300 and the magnetic units 100 are made of the same material and integrally formed.

The grooves 200 are provided on both sides of the magnetic element to block the eddy current path and reduce eddy current loss. The magnetic unit 100 is defined between each two adjacent grooves 110, and the connecting portion 300 is reserved to integrally connect two corresponding adjacent magnetic units 100 when the groove 100 is formed by cutting. The connecting portion 300 prevents the groove 200 from completely penetrating between the two adjacent magnetic units 100, so that the magnetic element is continuous and of a one-piece structure. Compared with the manner in the conventional technology that the segments being stacked, the stacking and bonding processes are omitted, which effectively improves the production efficiency of the magnetic element. Moreover, compared with the manner that the segments being stacked, excessive scrap materials being produced in the cutting process is avoided, which effectively improves the utilization rate of materials, in addition, adhesives required for the bonding process are omitted, thereby further reducing the cost.

The magnetic element may be made of an electrically conductive material, including a permanent magnet material with a certain electrical conductivity, such as neodymium-iron-boron, aluminum-nickel-cobalt, and samarium-cobalt. In addition, the magnetic element may be applied to an electric motor, an electromagnet, or other electromagnetic devices. The electric motor is classified into an axial flux motor and a radial flux motor, hence the shape of the magnetic element may also be various, for example, the magnetic element is in a regular shape such as a sector, a rectangle, a trapezoid, a polygon, or other irregular shapes. Four embodiments are illustrated hereinafter.

### First Embodiment

As shown in FIG. 2, the magnetic element is in a fan shape. The multiple magnetic units 100 are arranged along a radial direction of the fan shape. Lengths of the multiple magnetic units 100 are sequentially increased along the radial direction of the fan shape from inside to outside. In addition, an inner side of the fan shape of the magnetic element is a concave surface, and an outer side of the fan shape of the magnetic element is a convex surface, so that the magnetic element forms a fan-shaped structure as shown in FIG. 2.

Further, the connecting portion 300 is located at a middle position of the corresponding two adjacent magnetic units 100, so that grooves 200 are formed on both sides of the connecting portion 300. The grooves 200 on both sides of the connecting portions 300 are in one-to-one correspondence, and each of the grooves 200 is exposed on the corresponding side of the magnetic element where the groove 200 is located. The groove 200 located on the left side of the connecting portion 300 is taken as an example, the groove extends outward from the left side of the magnetic element to make the groove 200 on the left side be exposed on the left side of the magnetic element, and the groove 200 penetrates through the magnetic element in the thickness direction of the magnetic element. In this way, a cutting device can enter from the left side of the magnetic element, to form the groove 200 located on the left side of the connecting portion 300 along the track of the groove 200.

Furthermore, the grooves 200 located on both sides of each of the connecting portions 300 are in one-to-one correspondence and located on the same straight line. The reserved connecting portion 300 is formed between bottoms of the two grooves 200 that are in one-to-one correspondence, and the reserved connecting portion 300 functions to connect the corresponding two adjacent magnetic units 100 in an integral manner.

Referring to FIG. 2, the connecting portions 300 have the same length, and each of the connecting portions 300 is located at a middle portion of the magnetic element, so that the grooves 200 located on both sides of the connecting portion 300 are symmetrically arranged, that is, depths of the grooves 200 located on both sides of the corresponding connecting portion 300 are the same. Since the lengths of the magnetic units 100 are different, depths of the grooves 200 located between different magnetic units 100 are also different, and the groove 200 proximate to the outer side of the fan shape of the magnetic element is the longest.

Continuing to refer to FIG. 2, as the connecting portions 300 are located at the middle portion of the magnetic element, a line connecting centers of the multiple connecting portions 300 is perpendicular to the length direction of the magnetic unit 100, which ensures structural strength and prevents the reliability and stability of the structure of the magnetic element from being affected by the grooves 200.

It should be noted that, the thickness of the magnetic element keeps consistent, that is, two side surfaces of the magnetic element in the thickness direction are parallel to each other. The connecting portions 300 are reserved after the grooves 100 are formed by cutting, so the connecting portions 300 are flush with both sides of the magnetic element in the thickness direction.

In addition, the number of the magnetic units 100 and the number of the grooves 200 defined between the two adjacent magnetic units 100 may be determined based on actual operating conditions and in accordance with actual requirement principles of eddy current loss.

The width of the groove generally ranges from 0.05 to 0.2 mm, which may be selected according to design requirements.

An insulation layer is provided on an outer surface of the magnetic element 100, which is formed by integral electroplating or spraying. The insulation layer formed by spraying may be an epoxy insulation layer or a nickel insulation layer.

Preferably, the groove 200 is filled with an insulating material. The magnetic element is prevented from breaking by filling the groove 200 with the insulating material, thereby further improving the structural strength and the stability of the magnetic element, and ensuring the function of the groove 200 in blocking the eddy current path.

### Second Embodiment

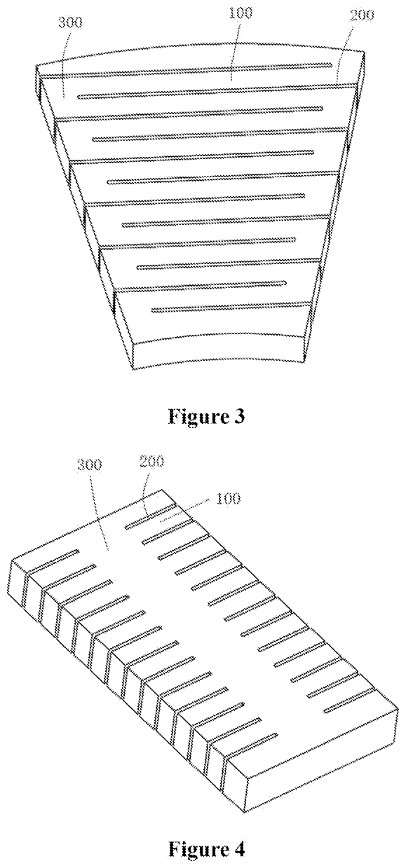

As shown in FIG. 3, a magnetic element according to the second embodiment is different from the magnetic element according to the first embodiment in that, one connecting portion 300 and one groove 200 are provided between each two adjacent magnetic units 100, and the grooves 200 are provided on both sides of the magnetic element in a staggered manner, so that a fan-shaped contour of the magnetic element is formed with S-shapes.

The multiple magnetic units 100 are arranged along the radial direction of the fan shape of magnetic element, and only one groove 200 is formed between each two adjacent magnetic units 100, so the multiple grooves 200 are also arranged along the radial direction of the fan shape of magnetic element. The grooves 200 are provided on the two sides of the magnetic element in a staggered manner, so that the magnetic element is of the structure having S-shapes. Referring to FIG. 3, in two adjacent grooves 200, the groove 200 located on the upper side penetrates from the left side of the magnetic element, and the corresponding connecting portion 300 is reserved on the right side of the magnetic element; the groove 200 located on the lower side penetrates from the right side of the magnetic element, and the corresponding connecting portion 300 is reserved on the left side of the magnetic element, so that the fan-shaped contour of the magnetic element is formed with S-shapes.

The connecting portions 300 have the same length, and since the lengths of the magnetic units 100 are different, the depths of the grooves 200 located between different magnetic units 100 are also different. The groove 200 proximate to the outer side of the fan shape of the magnetic element is the longest, so as to ensure the ability of blocking the eddy current loss.

### Third Embodiment

As shown in FIG. 4, a magnetic element according to the third embodiment is different from the magnetic element according to the first embodiment in that the magnetic element is in a shape of a rectangle. The multiple magnetic units 100 are arranged along the length direction of the rectangle of the magnetic element, so that the grooves 200 located on both sides of the connecting portions 300 are exposed on both sides of a width of the rectangle of the magnetic unit 100, and the depths of the grooves 200 between any two adjacent magnetic units 100 are the same.

### Fourth Embodiment

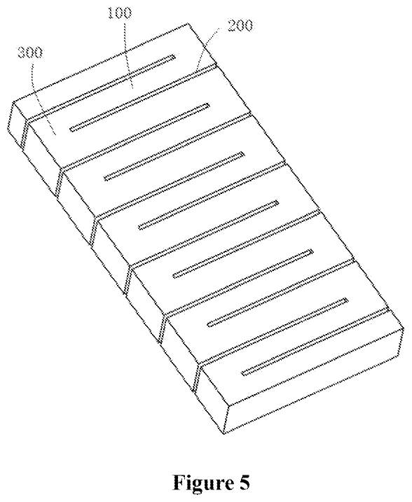

As shown in FIG. 5, a magnetic element according to the fourth embodiment is different from the magnetic element according to the second embodiment in that the magnetic element is in a shape of a rectangle. The grooves 200 are provided on both sides of the width of the magnetic element in a staggered manner, so that a fan-shaped contour of the magnetic element is formed with S-shapes. Besides, the grooves 200 on each of both sides have the same depth and are provided at intervals along the length direction of the magnetic element.

In summary, the grooves 200 are provided on both sides of the magnetic element to block the eddy current path and reduce the eddy current loss. The magnetic unit 100 is defined between each two adjacent grooves 110, and the connecting portion 300 is reserved to integrally connect two corresponding adjacent magnetic units 100 when the groove 100 is formed by cutting. The connecting portion 300 prevents the groove 200 from completely penetrating between the two adjacent magnetic units 100, so that the magnetic element is continuous and of a one-piece structure. Compared with the manner in the conventional technology that the segments being stacked, the stacking and bonding processes are omitted, which effectively improves the production efficiency of the magnetic element. Moreover, compared with the manner that the segments being stacked, excessive scrap materials being produced in the cutting process is avoided, which effectively improves the utilization rate of materials, in addition, adhesives required for the bonding process are omitted, thereby further reducing the cost. In addition, the grooves 200 located on both sides of the magnetic element may be arranged in a one-to-one correspondence or staggered manner to be adapted to the magnetic elements with different shapes, so that the magnetic element are provided with the grooves 200 that block the eddy current path on the premise that the structural strength of the magnetic element is ensured, thereby achieving implementability and improving applicability.

As shown in FIGS. 2 to 5, a method for manufacturing the magnetic element according to the above embodiments includes the following steps:
an integral magnetic element of a desired shape is prepared; and
the integral magnetic element is cut to form grooves 200 on both sides of the magnetic element, and a margin is reserved during cutting to form each of the connecting portions 300. The integral magnetic element with a specific shape is selected according to the desired contour shape of the magnetic element. Then, the groove 200 for blocking the eddy current path is formed by partially cutting the integral magnetic element and the connecting portion 300 is reserved, so that the magnetic element is continuous and formed in a one-piece structure. The connecting portion 300 is provided to prevent the groove 200 from completely penetrating between two adjacent magnetic units 100, so as to avoid the stacking and bonding processes which bring about disadvantages of time-consuming and laborious work and increased costs as well. In this way, the magnetic element has the grooves for blocking the eddy current path on the premise that the structure of the magnetic element is stable, which effectively improves the production efficiency.

The method further includes the following step: performing integral electroplating or spraying on the magnetic element after being cut, to form an insulation layer on a surface of the magnetic element.

The efficiency in forming the magnetic element is improved by means of integral electroplating and spraying. Moreover, the insulation layer formed by integral electroplating avoids the defect of poor adhesion caused by spraying.

The above embodiments are only used to illustrate technical ideas and characteristics of the present application, and the purpose thereof is to enable those skilled in the art to understand the content of the present application and implement it accordingly. The scope of the present application cannot be limited only by the embodiments, that is, any equivalent changes or modifications made in accordance with the principle disclosed in the present application shall fall within the scope of the present application.

1. A magnetic element comprising a plurality of magnetic units, the plurality of magnetic units being arranged in sequence, wherein a groove and a connecting portion are provided between each two adjacent magnetic units of the plurality of magnetic units, the groove is configured to block an eddy current path, the connecting portion is configured to connect the corresponding adjacent magnetic units, the connecting portion is connected to the groove to block the groove from completely penetrating between the adjacent magnetic units, and the connecting portion and the plurality of magnetic units are made of a same material and are integrally formed.

2. The magnetic element according to claim 1, wherein the connecting portion is located at a middle position of the corresponding two adjacent magnetic units, to allow the groove to be formed on each of both sides of the connecting portion.

3. The magnetic element according to claim 2, wherein a line connecting centers of the plurality of the connecting portions is perpendicular to a length direction of each of the plurality of magnetic units.

4. The magnetic element according to claim 1, wherein one said connecting portion and one said groove are provided between each two adjacent magnetic units, and the grooves are provided on both sides of the magnetic element in a staggered manner, to form the magnetic element being of a structure having S-shapes.

5. The magnetic element according to claim 2, wherein the connecting portion is flush with both sides of the magnetic element in a thickness direction.

6. The magnetic element according to claim 1, wherein the groove penetrates through the magnetic element in a thickness direction of the magnetic element.

7. The magnetic element according to claim 1, wherein a width of the groove ranges from 0.05 mm to 0.2 mm.

8. The magnetic element according to claim 1, wherein the groove is filled with an insulating material.

9. A manufacturing method for manufacturing the magnetic element according to claim 1, comprising:
preparing an integral magnetic element of a desired shape; and
cutting the integral magnetic element to form the groove on each of both sides of the magnetic element, and reserving a margin during cutting to form the connecting portion.

10. The manufacturing method according to claim 9, wherein overall electroplating or spraying is performed on the magnetic element after being cut, to form an insulation layer on a surface of the magnetic element.

11. The magnetic element according to claim 3, wherein the connecting portion is flush with both sides of the magnetic element in a thickness direction.

12. A manufacturing method for manufacturing the magnetic element according to claim 2, comprising:
preparing an integral magnetic element of a desired shape; and
cutting the integral magnetic element to form the groove on each of both sides of the magnetic element, and reserving a margin during cutting to form the connecting portion.

13. A manufacturing method for manufacturing the magnetic element according to claim 3, comprising:
preparing an integral magnetic element of a desired shape; and
cutting the integral magnetic element to form the groove on each of both sides of the magnetic element, and reserving a margin during cutting to form the connecting portion.

14. A manufacturing method for manufacturing the magnetic element according to claim 4, comprising:
preparing an integral magnetic element of a desired shape; and
cutting the integral magnetic element to form the groove on each of both sides of the magnetic element, and reserving a margin during cutting to form the connecting portion.

15. A manufacturing method for manufacturing the magnetic element according to claim 5, comprising:
preparing an integral magnetic element of a desired shape; and
cutting the integral magnetic element to form the groove on each of both sides of the magnetic element, and reserving a margin during cutting to form the connecting portion.

16. A manufacturing method for manufacturing the magnetic element according to claim 6, comprising:
preparing an integral magnetic element of a desired shape; and
cutting the integral magnetic element to form the groove on each of both sides of the magnetic element, and reserving a margin during cutting to form the connecting portion.

17. A manufacturing method for manufacturing the magnetic element according to claim 7, comprising:
preparing an integral magnetic element of a desired shape; and
cutting the integral magnetic element to form the groove on each of both sides of the magnetic element, and reserving a margin during cutting to form the connecting portion.

18. A manufacturing method for manufacturing the magnetic element according to claim 8, comprising:
preparing an integral magnetic element of a desired shape; and
cutting the integral magnetic element to form the groove on each of both sides of the magnetic element, and reserving a margin during cutting to form the connecting portion.
